(19) United States
(12) Patent Application Publication
(10) Pub. No.: US 2015/0316202 A1
(43) Pub. Date: Nov. 5, 2015

(54) Truss Adapter for Mounting Objects on Space Frame Truss

(71) Applicant: Entertainment Structural Products, Essington, PA (US)

(72) Inventor: Michael P.A. Chouinard, Swarthmore, PA (US)

(21) Appl. No.: 14/700,087

(22) Filed: Apr. 29, 2015

Related U.S. Application Data
(60) Provisional application No. 61/986,038, filed on Apr. 29, 2014.

(51) Int. Cl. F16M 13/02; F21V 21/26; F16B 2/08

(52) U.S. Cl. CPC F16M 13/022; F16B 2/08; F21V 21/26

(57) ABSTRACT

Devices for mounting objects on space frame truss are provided.

### BACKGROUND OF THE INVENTION

The present invention relates to the field of hanging objects on truss. Tubular truss is used in the entertainment industry in both temporary and permanent rigging systems to hold lights, speakers, and other entertainment equipment. There is a need in the construction industry for safe ways to attach objects to truss.

### BRIEF DESCRIPTION OF THE DRAWINGS

The features of the present invention are set forth with particularity in the appended claims. The present invention, both as to its organization and manner of operation, together with further objects and advantages thereof, may be best understood with reference to the following description, taken in connection with the accompanying drawings in which

FIG. 1 is a side view of an embodiment of the present invention hanging on a piece of triangular truss;

FIG. 2 is a front view of an embodiment of the present invention hanging on a piece of truss;

FIG. 3 is a side view of an embodiment of the present invention hanging on a piece of triangular truss;

FIG. 4 is a front view of an embodiment of the present invention hanging on a piece of truss; and

FIG. 5 is a side view of an embodiment of the present invention hanging on a piece of triangular truss.

### DETAILED DESCRIPTION OF THE INVENTION

The present invention is a device for mounting objects and coupling loads imposed by those objects to space frame trusses or beams in a manner which utilizes the full moment capacity in bending, shear and torsion of the space frame truss or other type of beam. The device in all of its embodiments entraps the cross section of the truss in such a way as to not locally load in torsion or local bending a truss chord or flange independent of the entire truss or beam structure.

Most truss mounts circumferentially clamp on a single truss chord with either a U-bolt or other type of circumferential clamp or a clamp which compresses on a flange of a beam. If a moment load is coupled through to the chord tube or flange through this attachment the local stresses in the tube or flange may become quite high as a result of the small length of engagement relative to the moment arm. This in combination with other stresses from bending or twisting of the structure that may be present become additive and cause unplanned local yielding of the structure.

Generally the choice is to hang loads from the lower truss chord or flange of a space frame truss or beam as it seems to be a convenient place to suspend a load. This may be the region of the highest tensile stress present in the structure as in triangular trusses which usually are oriented with a single chord in tension. This method can cause highly unpredictable stressing (local loading) of the structure and consequent sudden failure as an individual chord tube failure may cause a catastrophic and progressive failure of the whole structural element.

The devices of the present invention utilize the entire bending and moment capacity of die beam as intended as the device is configured to wrap around the entire structural member and apply a light compressive load with the tensioning device present in the mount body. In this way the mount couples its loads in bending, twisting, and moment loading effectively through the entire cross section of the structural member.

A small preload applied to the tension device in the mount body allows a large moment loading to be applied to the mount body and coupled to she structural member without causing excessive loading of any individual truss chord.

The mounts of the present invention may be tightened so as to grip the cross section of the beam or truss so as not to slide along its length if the beam is of uniform cross section. The mount may also be loosened without removing and slid along the length to any desired position unless obstructed by some non-uniform cross sectional feature. Because the device wraps around the outer perimeter of the truss, the location of the device will not be impeded by any internal truss chord members.

The mounts of the present invention may be used to hand any object off of space frame truss or a beam. Object include but are not limited to televisions, speakers, lights, other trusses. The mounts of the present invention are also not sensitive to the orientation of the beam or truss.

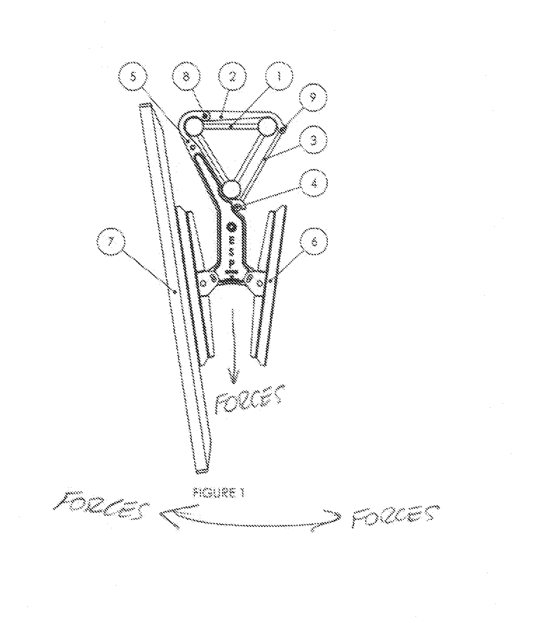

FIG. 1 shows a mount attached to a triangular truss (1) the mount has a pivoting arm (2) which contacts the truss with a radiused saddle feature and pivots (8) relative to the body of the mount (5). Drawbolt (3) pivots at the end of pivoting arm (2) at pivot (9) and connects at nut (4) which engages a slot in the body (5) which allows the mount to be preloaded when drawbolt (3) is threaded into nut (4) pulling it into the end of the slot feature in body (5). Bracket (6) is an adapter for attaching a television (7) to the body of the mount (5).

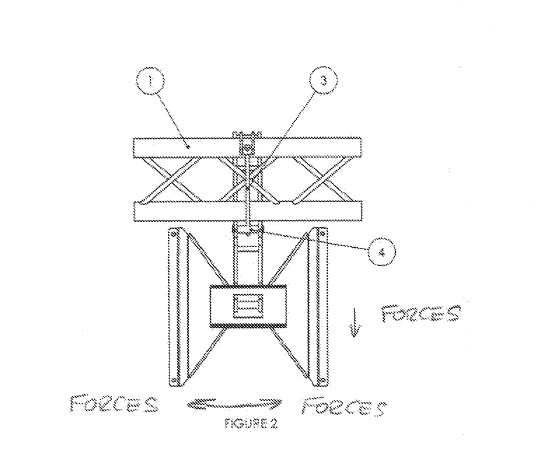

FIG. 2 shows a mount attached to a triangular truss (1). The drawbolt (3) and nut (4) are shown in the tightened configuration to demonstrate the communication of the working loads to the entire cross section of the truss (1).

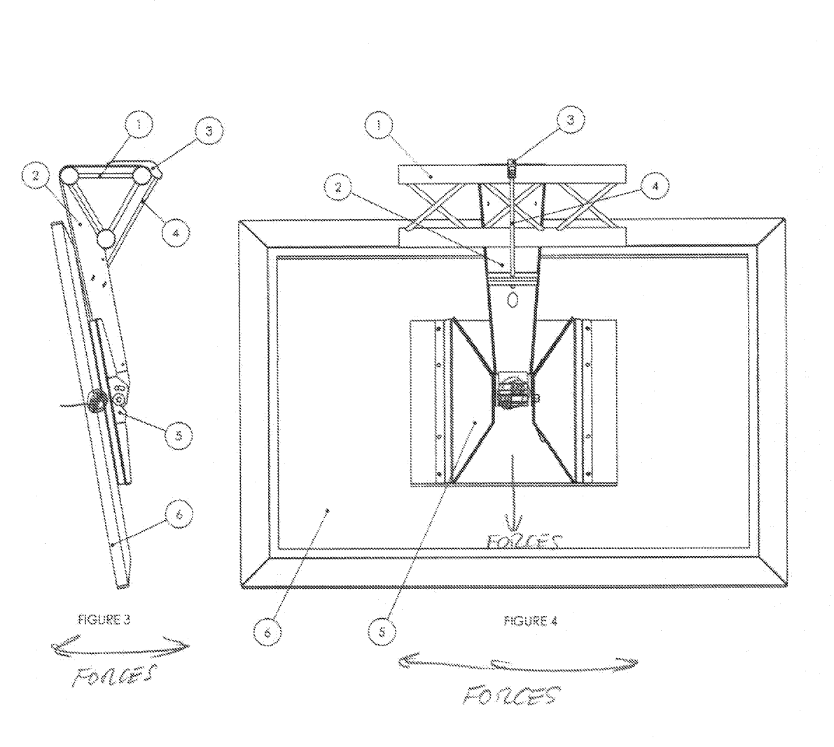

FIG. 3 shows another embodiment of the present invention, which is an unarticulated mount where the body of the mount (2) is a sheet metal fabrication on a truss (1) with a saddle (3) rigidly attached to the sheet metal body (2) and a drawbolt (4) provides the necessary preload to secure the mount axially on the truss. This embodiment relies on the flexure of the sheet metal body (2) to conform to the shape of the truss. Bracket (5) is an adapter for attaching a television (6) to the body of the mount (2)

FIG. 4 shows another view of art unarticulated mount where the body of the mount (2) is a sheet metal fabrication on a truss (1) with a saddle (3) rigidly attached to the sheet metal body (2) and a drawbolt (4) provides the necessary preload to secure the mount axially on the truss. This embodiment relies on the flexure of the sheet metal body (2) to conform to the shape of the truss. Bracket (5) is an adapter for attaching a television (6) to the body of the mount (2)

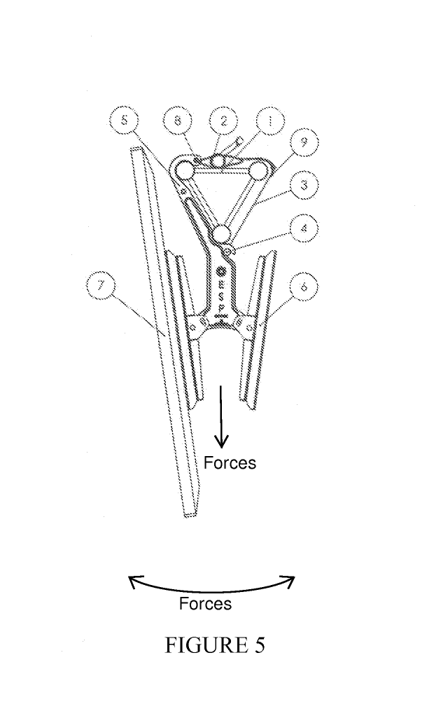

FIG. 5 shows another embodiment of the mounts of the present invention wherein the body of the mount (5) nests on the chord tubes of the truss (1) and the preload to restrain the body (5) of the mount to the truss (1) is provided by a ratcheting binder apparatus (2) pivoting on a pin (8) through the body (5) tensioning a flexible strap (3) and connecting back to the body (5) at connection (4) which may be of any suitable geometry or method. Bracket (6) is an adapter for attaching a television (7) to the body of the mount (5).

Various embodiments having been thus described in detail and by way of example, it will be apparent to those of skilled in the art that variations and modifications may be made and still achieve the desired outcome. The embodiments described herein include all such variations and modifications as fall within the scope of the claims.

What is claimed is:

1. A device comprising a mount body; wherein said device is configured to wrap around a structural member thereby applying compression to said structural member by generating a preload tension in said device.

2. The device as claimed in claim 1, wherein said device couples its loads in bending, twisting, and moment loading through the entire cross section of said structural member.

3. The device as claimed in claim 1, wherein said device may be loosened and slid along the length of the structural member.

4. The device as claimed in claim 1, wherein said structural member is round.

5. The device as claimed in claim 1, wherein said structural member is a polygonal-shaped truss.

6. A device comprising 1) a mount body; 2) a pivoting arm; and 3) a drawbolt; wherein said mount, said pivoting arm and said drawbolt wrap around a structural member thereby applying compression to said structural member by generating a preload tension in said device.

7. The device as claimed in claim 6, wherein said device couples its loads in bending, twisting, and moment loading through the entire cross section of said structural member.

8. The device as claimed in claim 6, wherein said device may be loosened and slid along the length of the structural member.

9. The device as claimed in claim 6, wherein said mount body is sheetmetal.

10. The device as claimed in claim 6, wherein a bracket is attached to said mount body.

11. The device as claimed in claim 6, wherein said bracket is adapted to hold an object selected from the group consisting of a television, a light, or a speaker.

12. A device comprising 1) a mount body; 2) a saddle; and 3) a drawbolt; wherein said mount, said saddle and said drawbolt wrap around a structural member thereby applying compression to said structural member by generating a preload tension in said device.

13. The device as claimed in claim 12, wherein said device couples its loads in bending, twisting, and moment loading through the entire cross section of said structural member.

14. The device as claimed in claim 12, wherein said device may be loosened and slid along the length of the structural member.

15. The device as claimed in claim 12, wherein said mount body is sheetmetal.

16. The device as claimed in claim 12, wherein said saddle is rigidly attached the mount body.

17. The device as claimed in claim 12, wherein a bracket is attached to said mount body.

18. The device as claimed in claim 12, wherein said bracket is adapted to hold an object selected from the group consisting of a television, a light, or a speaker.

19. A device comprising 1) a mount body; and 2) a ratcheting binder apparatus comprising a flexible strap and a ratchet binder; wherein said device wraps around a structural member, thereby applying compression to said structural member by generating a preload tension in said device.

20. The device as claimed in claim 19, wherein said device couples its loads in bending, twisting, and moment loading through the entire cross section of said structural member.

21. The device as claimed in claim 19, wherein said device may be loosened and slid along the length of the structural member.

22. The device as claimed in claim 19, wherein said mount body is aluminum.

23. The device as claimed in claim 19, wherein a bracket is attached to said mount body.

24. The device as claimed in claim 19, wherein said bracket is adapted to hold an object selected from the group consisting of a television, a light, or a speaker.
